(19) United States
(12) Patent Application Publication
(10) Pub. No.: US 2026/0200696 A1
(43) Pub. Date: Jul. 16, 2026

(54) METHOD FOR SWITCHING OFF THE OPERATION OF AN ELEVATOR, AND ELEVATOR CONTROLLER

(71) Applicant: INVENTIO AG, Hergiswil (CH)

(72) Inventor: Christian Studer, Kriens (CH)

(21) Appl. No.: 19/136,347

(22) PCT Filed: Dec. 5, 2023
(86) PCT No.: PCT/EP2023/084290

§ 371 Date: Jun. 6, 2025

(30) Foreign Application Priority Data
Dec. 13, 2022 (EP) 22213155.9

(51) Int. Cl. B66B 1/34; B66B 1/02; B66B 5/02

(52) U.S. Cl. CPC B66B 1/3407; B66B 1/02; B66B 1/3461; B66B 5/021; B66B 5/027

(57) ABSTRACT

A method for switching off the operation of an elevator includes steps of: receiving, by an elevator controller, a signal to shut down the elevator operation, wherein the received signal contains information about the time of an announced power outage; and after receiving the signal to shut down the elevator operation, putting the elevator controller into a switch-off mode. In the switch-off mode, the elevator controller checks whether the elevator is in an active operating state or in an idle state. If the elevator is in the idle state, the elevator controller issues a command to switch off elevator operation. If the elevator is in the active state and a door of an elevator car has not opened automatically within the predetermined time period, a battery-supported emergency operating mode and/or a forced evacuation operating mode of the elevator controller is initiated.

### FIELD

The invention relates to a method for switching off the operation of an elevator and to an elevator controller.

### BACKGROUND

In view of the possibility of a power shutdown occurring, there is a need to ensure that when the operation of an elevator is switched off, no passengers are locked in an elevator car with the elevator door closed and are unable to leave the elevator car.

In order to avoid such a situation, it is already known to equip an elevator with a battery-assisted emergency mode of operation which, in the event of a sudden power outage, allows the elevator to continue operating for a limited time so that the passengers in an elevator car can reach a floor at which the elevator door opens automatically so that the passengers can get out and, for example, leave the building in which the elevator is located doing so on foot via the stairwell without difficulty.

### SUMMARY

The invention is based on an object of providing a method for switching off the operation of an elevator and an elevator controller in which the time of switching off the power supply or the like is known at least approximately in advance.

This object is achieved by a method having the features specified in advantageous embodiments of the invention in the subject-matter of an elevator controller described herein.

The method for switching off the operation of an elevator specified herein provides the following features:
receiving, by an elevator controller, a signal for shutting down elevator operation,
after reception of the signal to shut down the elevator operation, putting the elevator controller into a switch-off mode,
in switch-off mode checking by the elevator controller whether the elevator is in an active operating state or in an idle state,
if the elevator is in the idle state, issuing a command by the elevator controller to switch off elevator operation.

In the method according to the invention, after receiving a signal to shut down the elevator operation, the elevator controller is first put into a switch-off mode. In this switch-off mode, a check is carried out to determine whether the elevator is in an active operating state or in an idle state. If the elevator is in the idle state, the elevator controller system then issues a command to switch off the elevator operation.

By checking whether the elevator is in an active operating state or in an idle state, the option is provided, in the event that the elevator is not in the idle state, of continuing elevator operation until the elevator car, which may contain passengers, has reached a floor and after reaching the floor the car door has automatically opened so that the passengers can get out. The elevator is in the idle state when the elevator car is currently at one of the floors of the building, there are no passengers in the elevator car, and there is currently no travel command.

In one embodiment of the invention, the elevator controller comprises a local operating unit and a central control unit arranged remotely from the elevator and connected to the elevator controller via a network. This creates the option of using the central control unit to inform the elevator controller from a distant location that a power outage is imminent and that the operation of the elevator controller must be switched off.

In one embodiment of the invention, the signal sent by the central control unit and received by the elevator controller contains information about the time of an announced power outage. This gives the elevator controller the option of, if necessary, initiating measures to shut down the operation of the elevator in an orderly manner.

In one embodiment of the invention, a time period is specified which lies before the time of the announced power outage. In this embodiment, the elevator controller can, for example, check whether the available time period is only sufficient for the moving elevator car to reach the nearest floor, or whether the available time period is even sufficient for the moving elevator car to reach the ground floor of the building.

According to an embodiment of the invention, a predetermined time period is stored in a work program of the elevator controller and can be retrieved from there when required.

According to an embodiment of the invention, the predetermined time period is transmitted from the central control unit to the elevator controller together with the signal received by the elevator controller. This enables the central control unit to select the specified time period differently depending on the individual case. If, for example, a power outage has been announced and is imminent, the specified time period can or must be selected to be short. However, if the announced power outage will not occur until a later time, the specified time period can be selected to be longer.

According to an embodiment of the invention, the elevator controller is put into the switch-off mode only after the start of the predetermined time period. In many cases, this allows the elevator to operate for longer so that existing travel commands can be processed completely.

According to an embodiment of the invention, if the elevator is in the active operating state after receiving the signal to shut down the elevator operation, new travel commands will be blocked by the elevator controller, i.e. not be accepted.

According to an embodiment of the invention, when the elevator is in the active operating state after receiving the signal to shut down the elevator operation, elevator operation will be continued until an elevator car has reached a predetermined floor and a door of the elevator car has automatically opened.

According to an embodiment of the invention, if the elevator is in an active state after receiving the signal to shut down the elevator operation and the door of the elevator car has not opened automatically within the predetermined period of time, a battery-supported emergency operation mode and/or a forced evacuation operation mode of the elevator controller will be initiated.

According to an embodiment of the invention, the elevator operation is switched off by means of a switch controlled by the elevator controller, which is arranged in a power supply line of the elevator.

According to an embodiment of the invention, an elevator controller is designed to control a method for switching off the operation of an elevator.

The above embodiments can be used both individually and together, provided they are not mutually exclusive.

### DESCRIPTION OF THE DRAWINGS

In the following, exemplary embodiments of the invention are explained in more detail. In the drawings:

FIG. 1 shows a first exemplary embodiment of a device for switching off the operation of an elevator,

FIG. 2 shows a second exemplary embodiment of a device for switching off the operation of an elevator,

FIG. 3 shows a flow chart illustrating a method for switching off the operation of an elevator, and

FIG. 4 shows a flow chart illustrating another method for switching off the operation of an elevator.

### DETAILED DESCRIPTION

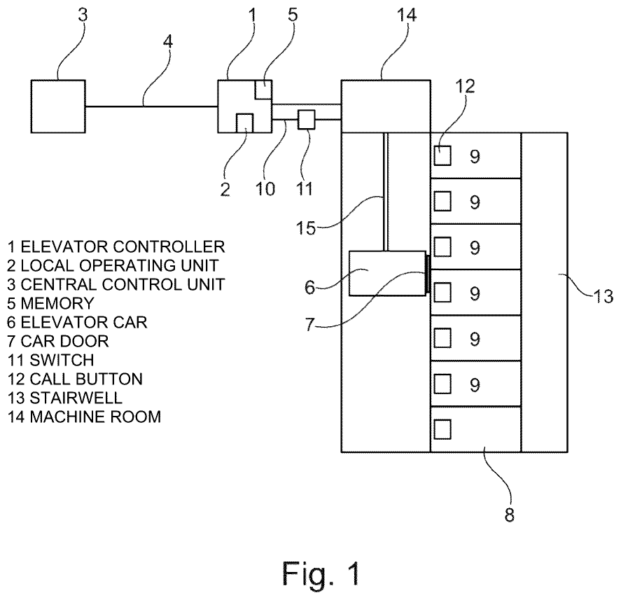

FIG. 1 shows a first exemplary embodiment of a device for switching off the operation of an elevator. This exemplary embodiment can be used when, for example, an electricity company intends to interrupt the power supply to a large number of electricity consumers at a previously known time. In this case, in a multi-story building in which the individual floors are accessible by means of an elevator, it is necessary to ensure that at the time of the power outage no persons are locked in an elevator car and not able to leave the elevator car.

The following components are shown in FIG. 1: an elevator controller 1, a local operating unit 2 of the elevator controller, a central control unit 3, a network 4, a memory 5 in which a work program of the elevator controller is stored, an elevator car 6, a door 7 of the elevator car, the ground floor 8 of the multi-story building, further floors 9 of the multi-story building, a power supply line 10 of the elevator, a switch 11 for switching off the operation of the elevator, call buttons 12 for calling the elevator car, the stairwell 13 of the multi-story building, the machine room 14, connected to the elevator controller 1, of the elevator, and cables 15 on which the elevator car 6 is suspended.

In this first exemplary embodiment, a signal to shut down the elevator operation is transmitted from a central control unit 3 via a network 4. This signal is received by a local elevator controller 1, which is arranged within the multi-story building and is designed to control the elevator operation. The central control unit 3 can be located far away from the local elevator controller 1, for example in a cloud, and is connected to the local elevator controller 1 via the network 4.

As already explained, the signal received by the local elevator controller 1 contains a signal to shut down elevator operation. After receiving this signal to shut down elevator operation, the elevator controller 1 is put into a switch-off mode. In this switch-off mode, the elevator controller 1 checks whether the elevator is currently in an active operating state or in an idle state. The elevator is in the idle state when the elevator car 6 is currently at one of the floors of the building, there are no passengers in the elevator car 6 and there is currently no travel command. If the elevator is in such an idle state, the elevator controller 1 will issue a command to switch off elevator operation.

This command to switch off elevator operation is transmitted from the elevator controller 1 to a switch 11 arranged in the power supply line 10 of the elevator, which is opened to switch off elevator operation.

In one embodiment of the invention, the signal emitted by the central control unit 3 contains information about the time of an announced power outage. This information about the time of the announced power outage is received by the local elevator controller 1.

Furthermore, according to an embodiment of the invention, the signal transmitted by the central control unit 3 contains information about a time period which is before the time of the announced power outage. This time period is, for example, 10 minutes long, but can be selected to be longer or shorter if necessary. This signal, which contains information about the time period, is also received by the local elevator controller 1 and stored together with a work program in a memory 5 of the local elevator controller.

According to a further embodiment of the invention, the information about the time period can also be permanently stored in a work program of the elevator controller stored in the memory 5 of the local elevator controller 1. In this further embodiment, there is no need for this information to be transmitted over the period of time from the central control unit 3 to the local elevator controller 1.

In the two embodiments described above, the elevator controller 1 can initially continue to operate in normal mode and be switched into the switch-off mode only after the start of the period of time.

In this case, as already explained above, after the elevator controller is put into switch-off mode, a check is carried out to determine whether the elevator is in an active operating state or in an idle state.

If the elevator is in an idle state, then, as already explained above, the elevator operation will be switched off by means of the switch 11 controlled by the elevator controller.

If, however, the elevator is in an active operating state, elevator operation will continue until the elevator car 6 has reached a predetermined floor and the door 7 of the elevator car 6 has opened automatically so that all passengers in the elevator car 6 can get out.

The specified floor can be the nearest floor. From there, passengers who have left the elevator car 6 can leave the multi-story building via the building's stairwell 13.

If a comparison of the specified time period of, for example, 10 minutes with the time required for the elevator car 6 to reach the ground floor 8 of the building shows that the elevator car will be able to reach the ground floor, then the specified floor at which the passengers can get out can also be the ground floor of the building.

If a comparison of the specified time period of, for example, 10 minutes with the time that the elevator car still needs to reach the ground floor 8 of the building shows that the elevator car will no longer be able to reach the ground floor within the stated time period, then a battery-supported emergency operating mode will be initiated in order to transport the passengers in the elevator car 6 either to the nearest floor or to the ground floor of the building so that they can get out there and not stay locked in the elevator car. In addition or alternatively, a forced evacuation mode of the elevator controller can also be initiated.

If the elevator is in the active operating state within the specified time period, new travel commands will be blocked by the elevator controller 1, i.e. no longer be accepted.

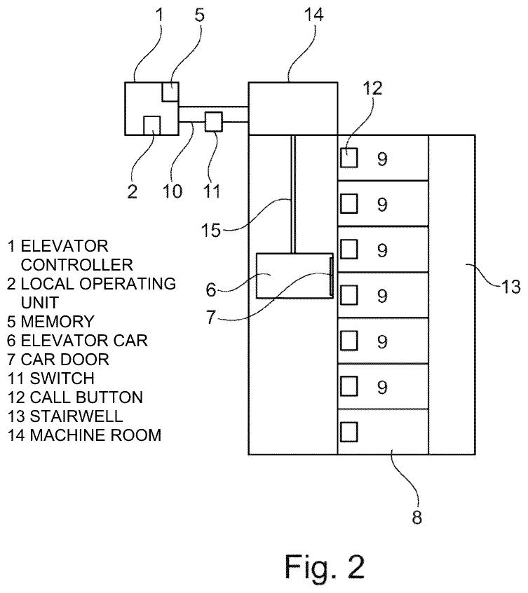

FIG. 2 shows a second exemplary embodiment of a device for switching off the operation of an elevator. This second exemplary embodiment differs from the first exemplary embodiment described above in that the central control unit is contained in the local elevator controller 1. This second exemplary embodiment can be used when a power switch-off is to be carried out only locally within a multi-story building. In this case, there is no need to transmit a signal to switch off the elevator operation from a remotely located central control unit to the local elevator controller 1 via a network. In this second exemplary embodiment, the signal for the desired switching-off of elevator operation can, for example, be input locally by means of an operating unit 2 of the local elevator controller 1.

If this locally generated signal was input to switch off elevator operation, it will then be used by the local elevator controller 1 to control the method according to the invention.

The following components are shown in FIG. 2: an elevator controller 1, a local operating unit 2 of the elevator controller, a memory 5 in which a work program of the elevator controller is stored, an elevator car 6, a door 7 of the elevator car, the ground floor 8 of the multi-story building, further floors 9 of the multi-story building, a power supply line 10 of the elevator, a switch 11 for switching off the operation of the elevator, call buttons 12 for calling the elevator car, the stairwell 13 of the multi-story building, the machine room 14, connected to the elevator controller 1, of the elevator, and cables 15 on which the elevator car 6 is suspended.

FIG. 2 illustrates that this second exemplary embodiment also provides a device for switching off the operation of an elevator which is arranged in a multi-story building. In this second exemplary embodiment as well, the power supply to the elevator is to be interrupted at a previously known time. In this case as well, in the multi-story building in which the individual floors are accessible by means of an elevator, it is necessary to ensure that at the time of the power outage no persons are locked in an elevator car and not able to leave the elevator car.

After the local elevator controller 1 receives the signal to switch off elevator operation, the elevator controller 1 is put into a switch-off mode. In this switch-off mode, the elevator controller 1 checks whether the elevator is currently in an active operating state or in an idle state. The elevator is in the idle state when the elevator car 6 is currently at one of the floors of the building, there are no passengers in the elevator car 6 and there is currently no travel command. If the elevator is in such an idle state, the elevator controller 1 will issue a command to switch off elevator operation.

This command to switch off elevator operation is transmitted from the elevator controller 1 to a switch 11 arranged in the power supply line 10 of the elevator, which is opened to switch off elevator operation.

Furthermore, in this second exemplary embodiment, information about a time period prior to the time of the announced power outage is stored in a memory 5 of the local elevator controller 1. This time period is, for example, 10 minutes long, but if required can also be selected or specified to be longer or shorter using the local operating unit 2. This information about the specified time period is stored together with the work program of the elevator controller in the memory 5 of the elevator controller and can be retrieved from there if required.

In this second exemplary embodiment as well, the elevator controller 1 can also initially continue to operate in normal mode and be switched to the switch-off mode only after the start of the period of time.

After the elevator controller is put into switch-off mode, a check is carried out to determine whether the elevator is in an active operating state or in an idle state.

If the elevator is in an idle state, then, as already explained above, the elevator operation will be switched off by means of the switch 11 controlled by the elevator controller 1.

If, however, the elevator is in an active operating state, the elevator operation will continue until the elevator car 6 has reached a predetermined floor and the door 7 of the elevator car 6 has opened automatically so that all passengers in the elevator car 6 can get out.

The specified floor can be the nearest floor. From there, passengers who have left the elevator car 6 can leave the multi-story building via the building's stairwell 13.

If a comparison of the specified time period of, for example, 10 minutes with the time required for the elevator car 6 to reach the ground floor 8 of the building shows that the elevator car will be able to reach the ground floor within the specified time period, then the specified floor at which the passengers will be able to get out can also be the ground floor 8 of the building.

If a comparison of the specified time period of, for example, 10 minutes with the time that the elevator car still needs to reach the ground floor 8 of the building shows that the elevator car will no longer be able to reach the ground floor within the stated time period, then a battery-supported emergency operating mode will be initiated in order to transport the passengers in the elevator car 6 either to the nearest floor or to the ground floor of the building so that they can get out there and not stay locked in the elevator car. In addition or alternatively, a forced evacuation mode of the elevator controller can also be initiated.

If the elevator is in the active operating state within the specified time period, new travel commands will be blocked by the elevator controller 1, i.e. no longer accepted.

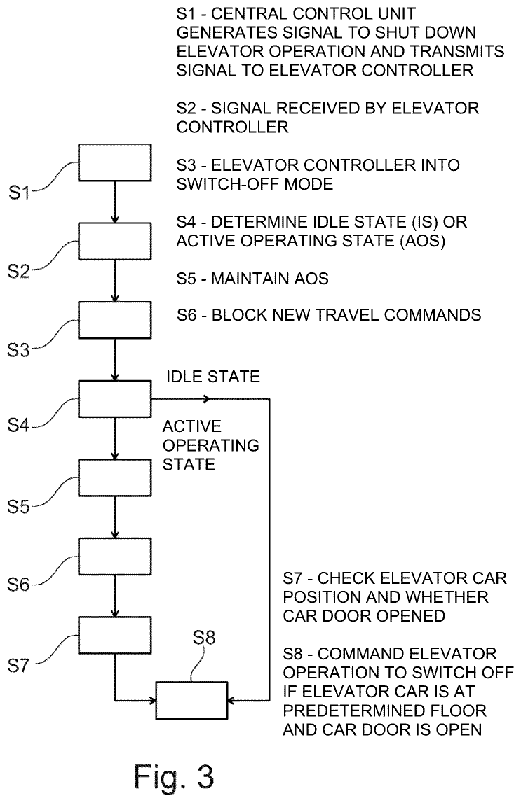

FIG. 3 shows a flow chart illustrating a method for switching off the operation of an elevator. This method works as follows:
In a step S1, a signal for shutting down the elevator operation is generated by a central control unit 3 and transmitted via a network 4 to a local elevator controller 1.

In a subsequent step S2, the signal transmitted via the network 4 is received by the local elevator controller 1.

In a step S3 the elevator controller 1 is then put into a switch-off mode.

In a subsequent step S4, in the switch-off mode, the elevator controller 1 checks whether the elevator is in an active operating state or in an idle state.

If it is determined in step S4 that the elevator is in the idle state, then the system will go on to step S8, in which the elevator controller 1 issues a command to switch off elevator operation.

However, if it is detected in step S4 that the elevator is in an active operating state, then the system will go on to step S5, in which the active operating state of the elevator is maintained.

The system then proceeds to step S6, in which new travel commands are blocked by the elevator controller 1, i.e. they are not accepted.

The system then goes on to step S7, in which it is checked whether the elevator car 6 has reached a predetermined floor and the door of the elevator has opened, or whether this is not the case.

If the check in step S7 shows that the elevator car 6 has reached a predetermined floor and the door 7 of the elevator has opened, then the system will go on to step S8, in which the elevator controller issues a command to switch off elevator operation.

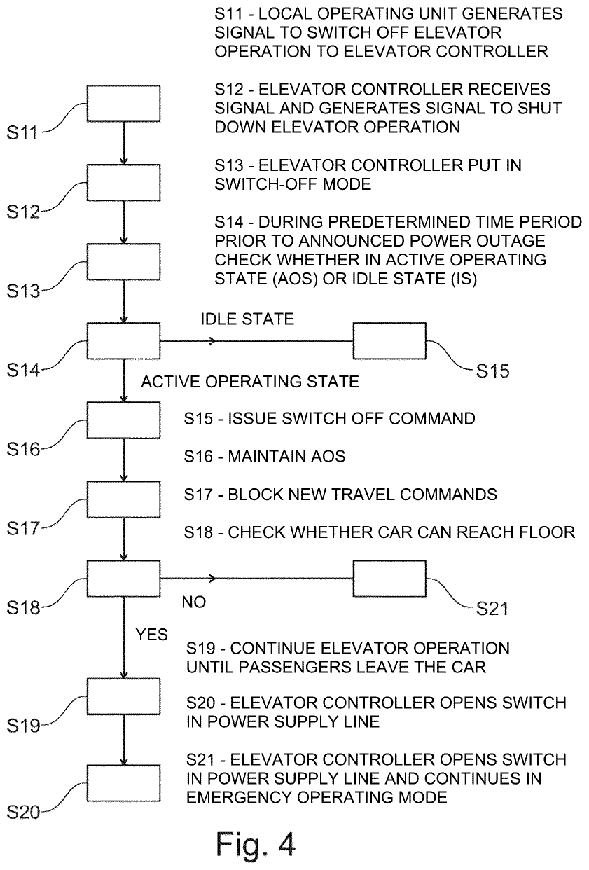

FIG. 4 shows a flow chart illustrating another method for switching off the operation of an elevator, wherein the switching-off of the elevator operation is to take place at a time known in advance. This method works as follows:
In a step S11, a signal for switching off the elevator operation is generated by a local operating unit 2 and is provided to the local elevator controller 1.

In a subsequent step S12, the signal generated by the local operating unit 2 is received by the local elevator controller 1 and the local elevator controller 1 generates therefrom a signal to shut down elevator operation.

In a step S13 the elevator controller 1 is then put into a switch-off mode.

In a subsequent step S14, in the switch-off mode, during a predetermined period of time prior to the time of the announced power outage, the elevator controller 1 checks whether the elevator is in an active operating state or in an idle state. The specified time period can be permanently stored together with the work program of the elevator controller in the memory 5 of the elevator controller 1 and can be retrieved from there, or can be individually specified by means of the operating unit 2.

If it is detected in step S14 that the elevator is in the idle state, then the system will go on to step S15, in which the elevator controller 1 issues a command to switch off elevator operation.

However, if it is detected in step S14 that the elevator is in an active operating state, then the system will go on to step S16, in which the active operating state of the elevator is maintained.

The system then proceeds to step S17, in which new travel commands are blocked by the elevator controller 1, i.e. they are not accepted.

The system then goes to step S18, in which it is checked whether the elevator car 6 will be able to reach a predetermined floor within the predetermined time period and whether the door 7 of the elevator car 6 can open there or whether this cannot happen within the predetermined time period.

If the check in step S18 shows that the elevator car 6 will be able to reach the specified floor within the specified time period and the door 7 of the elevator car 6 will be able to open there, then the system will go on to step S19, in which elevator operation is continued until the door 7 of the elevator car 6 has opened at the specified floor and the passengers are able to get out there.

Then, in a step S20, the elevator controller 1 issues a command to switch off elevator operation and the elevator operation is switched off by opening the switch 11 arranged in the power supply line 10 of the elevator.

If, however, the check in step S18 shows that the elevator car 6 will not be able to reach the specified floor within the specified time period and the door 7 of the elevator car cannot be opened within the specified time period, then in a step S21 the elevator controller 1 will switch off elevator operation by opening the switch 11 arranged in the power supply line of the elevator and a battery-supported emergency operating mode will be initiated in order to enable the elevator car 6 to continue traveling with battery support to the next floor or to the ground floor 8 of the multi-story building and the passengers be able to leave the elevator car 6 there.

In accordance with the provisions of the patent statutes, the present invention has been described in what is considered to represent its preferred embodiment. However, it should be noted that the invention can be practiced otherwise than as specifically illustrated and described without departing from its spirit or scope.

1-10. (canceled)

11. A method for switching off elevator operation of an elevator, the method comprising steps of:
receiving, by an elevator controller of the elevator, a signal to shut down the elevator operation, wherein the received signal contains information about a time of an announced power outage;
in response to reception of the signal to shut down the elevator operation putting the elevator controller into a switch-off mode;
when in the switch-off mode, the elevator controller checking whether the elevator is in an active operating state or in an idle state;
when the checking determines that the elevator is in the idle state, issuing a command by the elevator controller to switch off the elevator operation; and
when the checking determines that the elevator is in the active operating state and a door of an elevator car of the elevator has not opened automatically within a predetermined time period before the time of the announced power outage, initiating a battery-supported emergency operating mode and/or a forced evacuation operating mode of the elevator controller.

12. The method according to claim 11 wherein the elevator controller includes a local operating unit, at the elevator, and a central control unit, the central control unit being arranged remotely from the elevator and connected to the elevator controller via a network.

13. The method according to claim 11 including specifying a length of the predetermined time period depending upon the time of the announced power outage.

14. The method according to claim 11 including storing the predetermined time period in a work program of the elevator controller.

15. The method according to claim 11 including transmitting the predetermined time period to the elevator controller together with the signal received by the elevator controller.

16. The method according to claim 11 including putting the elevator controller into the switch-off mode after a beginning of the predetermined time period.

17. The method according to claim 11 including, when the elevator is in the active operating state during the switch-off mode, blocking new travel commands by the elevator controller.

18. The method according to claim 11 including, when the elevator is in the active operating state during the switch-off mode, continuing the elevator operation until the elevator car has reached a predetermined floor and the door of the elevator car has automatically opened.

19. The method according to claim 11 including switching-off the elevator operation by opening a switch controlled by the elevator controller, the switch being arranged in a power supply line of the elevator.

20. An elevator controller controlling operation of an elevator, the elevator controller comprising:
a memory storing a work program for controlling the operation of the elevator; and
wherein the elevator controller is adapted to respond to a signal to shut down the elevator operation by preforming the method according to claim 11.

21. An elevator comprising:
an elevator controller;
a machine room connected to the elevator controller by a power supply line;
an elevator car movable between floors of a building;
wherein the elevator controller is adapted to receive a signal to shut down the elevator operation, the received signal containing information about a time of an announced power outage at the power supply line;
wherein the elevator controller responds to reception of the signal by putting the elevator controller into a switch-off mode;
wherein the elevator controller, when in the switch-off mode, checks whether the elevator is in an active operating state or in an idle state;
when the elevator controller checking determines that the elevator is in the idle state, the elevator controller issues a command to switch off the elevator operation by opening a switch in the power supply line; and
when the elevator controller checking determines that the elevator is in the active operating state and a door of the elevator car of the elevator has not opened automatically within a predetermined time period before the time of the announced power outage, the elevator controller initiates a battery-supported emergency operating mode and/or a forced evacuation operating mode of the elevator controller.

22. The elevator according to claim 21 wherein the elevator controller includes a local operating unit that generates the signal.

23. The elevator according to claim 21 wherein the elevator controller is connected to a network to receive the signal from a central control unit that generates the signal and is connected to the network.
